(19) United States
(12) Patent Application Publication
(10) Pub. No.: US 2008/0135111 A1
(43) Pub. Date: Jun. 12, 2008

(54) Apparatus for preventing explosion

(76) Inventor: Seong Hack Lee, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/648,834

(22) Filed: Dec. 28, 2006

(30) Foreign Application Priority Data
Dec. 7, 2006 (KR) 10-2006-0124071

(51) Int. Cl. F16K 15/00; F16K 17/00

(52) U.S. Cl. 137/539

(57) ABSTRACT

To prevent explosion of an air tank in a vehicle collision, an apparatus includes a case defining a passage, configured for air stored in the air tank to be exhausted therethrough, the case being mounted to the air tank; a stopper movably disposed in the case and configured to selectively intercept the air based on a position thereof; an elastic member supporting the stopper; and at least one hook configured to secure the stopper in a position at which the air is exhausted.

### CROSS-REFERENCE TO RELATED APPLICATION

This application claims priority to and the benefit of Korean Patent Application No. 10-2006-0124071 filed in the Korean Intellectual Property Office on Dec. 07, 2006 the entire contents of which are incorporated herein by reference.

### BACKGROUND OF THE INVENTION

(a) Field of the Invention

The present invention relates to an apparatus for preventing an explosion of an air tank of a vehicle in a collision.

(b) Description of the Related Art

Typically, an air suspension includes an air spring and an air tank. Pressurized air stored in the air tank is supplied to the air spring to maintain pressure of the air spring. Therefore, the pressure in the air tank is high, for example, 14 to 16 bar. In a collision, the air tank may explode.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides an apparatus for preventing explosion of an air tank including a case, defining a passage through which air stored in the air tank is exhausted, the case being mounted to the air tank; a stopper to selectively intercept the air, movable within the case; an elastic member supporting the stopper; and at least one hook for securing the stopper at a position in which the air is exhausted.

The apparatus for may further include a sealing member mounted between the stopper and the case.

A groove may be provided on an interior surface of the case and configured for insertion of the at least one hook.

The stopper may be substantially spherical, and may be made of a steel material.

The sealing member may be made of a rubber.

### BRIEF DESCRIPTION OF THE DRAWINGS

FIG. 1 shows an apparatus for preventing explosion of an air tank mounted to the air tank according to an exemplary embodiment of the present invention.

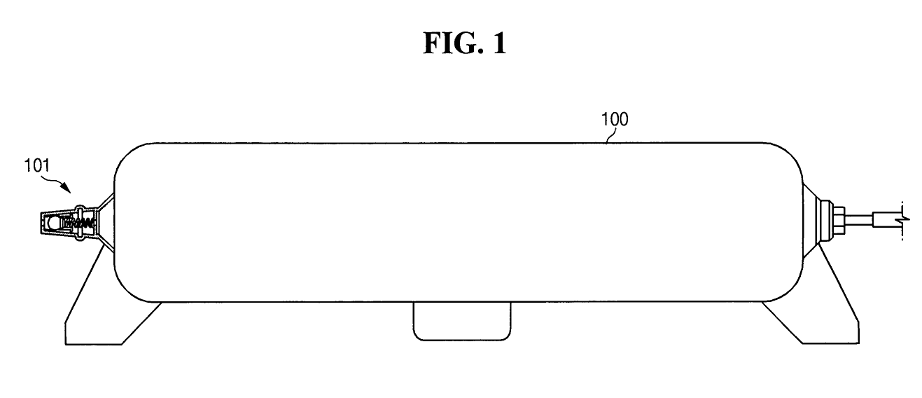

FIG. 2 is an enlarged view of the apparatus of FIG. 1.

FIG. 3 shows an operation state of the apparatus of FIG. 2.

### DETAILED DESCRIPTION OF THE PREFERRED EMBODIMENTS

An exemplary embodiment of the present invention will hereinafter be described in detail with reference to the accompanying drawings.

An apparatus 101 for preventing explosion of an air tank 100 includes a case 201, a stopper, such as ball 203, an elastic member 205, and at least one hook 207.

The case 201 defines a passage 212 through which air stored in the air tank 100 is exhausted. The case 201 is mounted to the air tank 100.

The ball 203 is movable within the case 201, and selectively intercepts the air depending on a position thereof. The elastic member 205 supports the ball 203.

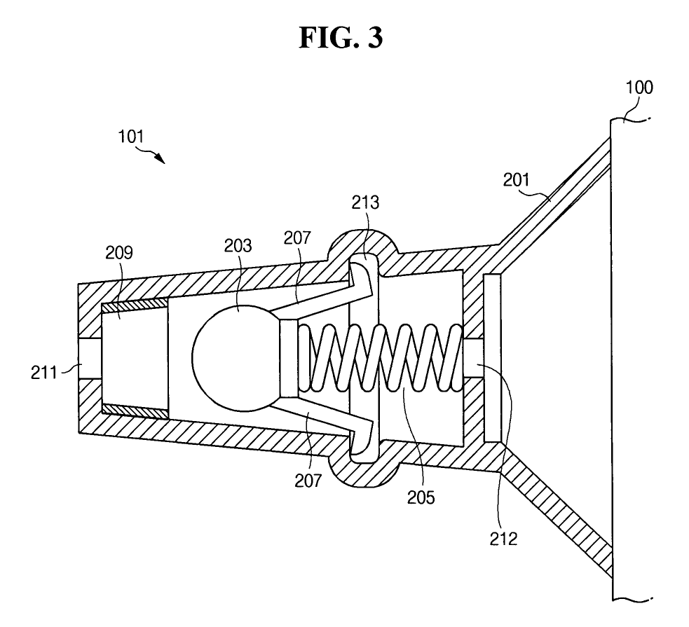

Referring to FIG. 3, the at least one hook 207 secures the ball 203 in a position at which the air is exhausted.

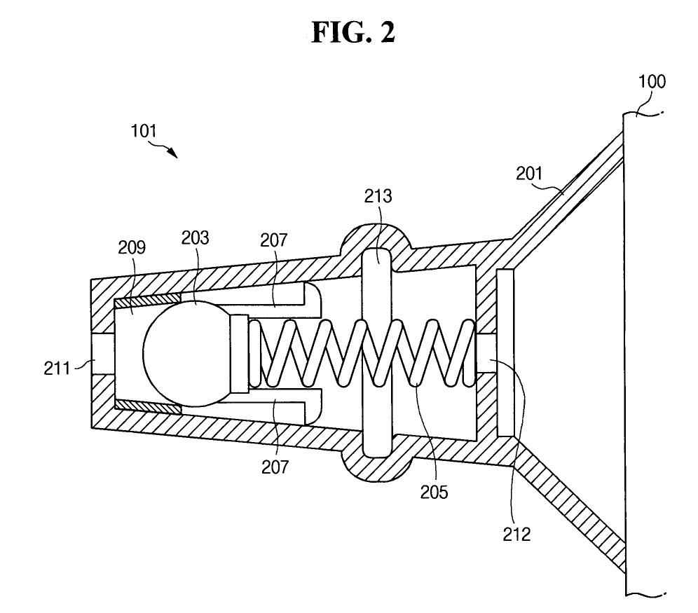

During normal operation, as seen in FIG. 2, the ball 203 intercepts an air exhaust hole 211 by abutting a rubber sealing member 209, disposed between the ball 203 and the case 201.

A groove 213 is provided on an interior surface of the case 201 and configured for the at least one hook 207 to be disposed therein.

In a collision, vibrations are generated, and the ball 203 moves to the right in the drawing. The hook 207 is caught in the groove 213. The hook 207 has an elastic force in an exterior direction of the case 201. Therefore, when the ball 203 moves to the right in the drawing, the hook 207 is caught in the groove 213. When the ball 203 moves, the air in the air tank 100 sequentially passes through the passage 212 and the air exhaust hole 211, and is exhausted to outside of the air tank 100. Therefore, during a collision, the air is exhausted, preventing explosion of the air tank 100.

The ball 203 may be made of steel. Elastic force of the elastic member 205 and weight of the ball 203 can be selected experimentally based on vehicle type and air tank type.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for preventing explosion of an air tank, comprising:
a case defining a passage, configured for air stored in the air tank to be exhausted therethrough, the case being mounted to the air tank;
a stopper movably disposed in the case and configured to selectively intercept the air based on a position thereof;
an elastic member supporting the stopper; and
at least one hook configured to secure the stopper in a position at which the air is exhausted.

2. The apparatus of claim 1, further comprising a sealing member between the stopper and the case.

3. The apparatus of claim 1, further comprising a groove on an interior surface of the case, configured for the at least one hook to be disposed therein.

4. The apparatus of claim 1, wherein the stopper comprises steel.

5. The apparatus of claim 2, wherein the sealing member comprises rubber.

6. The apparatus of claim 1, wherein the stopper is substantially spherical.
